(19) United States
(12) Patent Application Publication
(10) Pub. No.: US 2011/0167182 A1
(43) Pub. Date: Jul. 7, 2011

(54) TRANSPORT PRIORITIZATION BASED ON MESSAGE TYPE

(75) Inventors: Arto Palin, Viiala (FI); Jukka Reunamäki, Tampere (FI)

(73) Assignee: Nokia Corporation, Espoo (FI)

(21) Appl. No.: 12/652,129

(22) Filed: Jan. 5, 2010

(51) Int. Cl. G06F 13/42

(52) U.S. Cl. 710/105

(57) ABSTRACT

A system for controlling message transmission in an apparatus. Messages pending for transmission in an apparatus may be analyzed in order to determine a type for each message. The type determined for each message may then be utilized to select a transport set comprising one or more transports. The apparatus may select a transport from the transport set and may then transmit the pending messages using the selected transport.

### BACKGROUND

1. Field of Invention

Various example embodiments of the present invention relate to inter-apparatus communication, and in particular, to transport selection in an apparatus based on message type.

2. Background

A global communication infrastructure is emerging wherein apparatuses rely upon one or more other apparatuses for providing various functionality. For example, individual apparatuses may operate to provide resources that assist users when engaging in audible and/or visual communication, managing schedules, performing financial transactions, obtaining desired information, etc. Processes such as these, while appearing to act locally, may rely heavily upon interactions with various types of remote resources in order to execute their respective function. Often local operational elements such as communication interfaces, browsers, applications, etc. will utilize wireless communication in order to transmit and/or receive information that may be necessary in order to complete the function that was requested from the apparatus by the user.

Apparatus functionality such as described above not only relies upon accessing desired and/or required resources, but also in determining how these resources may be provided. For example, different apparatuses may be able to provide the same (or similar) services in an environment where many apparatuses are interacting via different forms of wired and/or wireless communication. However, as the many apparatuses may employ a multitude of communication protocols, the identification of particular apparatuses that can provide the desired resource may be complicated by the manner in which the desired resource is obtainable. For example, various communication protocols may provide methodologies for advertising services that are available via the particular communication protocol. Such methods for obtaining service information may therefore omit services available in an apparatus that cannot operate using the communication protocol. Moreover, each apparatus may employ a different set of communication protocols, and thus, may require that an apparatus seeking a resource inquire with each apparatus individually.

### SUMMARY

Various example embodiments of the present invention may be directed to at least a method, apparatus, computer program product and system for controlling message transmission in an apparatus. Messages pending for transmission in an apparatus may be analyzed in order to determine a type for each message. The type determined for each message may then be utilized to select a transport set comprising one or more transports. The apparatus may select a transport from the transport set and may then transmit the pending messages using the selected transport.

In accordance with at least one example embodiment of the present invention, the pending messages may be analyzed in order to determine if they are control-type messages or data-type messages. Control-type messages and data-type messages may each have a transport set comprising one or more wired or wireless transports. The one or more wired or wireless transports in each transport set may further be arranged in a priority order. For example, priority may be based on various parameters pertaining to the apparatus itself, the environment in which the apparatus is operating, information derived from a network, etc. An apparatus may select one of these transports sets as a part of preparations for transmitting pending messages.

For example, the selection of a transport from a previously selected transport set may encompass determining usable transports and selecting a usable transport having the highest priority. Usable transports may include any transports that are supported both in the transmitting apparatus and in any apparatus that is intended as a target for the pending messages. The usable transport having the highest priority in both apparatuses may be utilized for transmitting the messages. Moreover, the priorities established in each of the transport sets may be reformulated in view of changing conditions in the apparatus, the receiving apparatus, the environment, etc.

The foregoing summary includes example embodiments of the present invention that are not intended to be limiting. The above embodiments are used merely to explain selected aspects or steps that may be utilized in implementations of the present invention. However, it is readily apparent that one or more aspects, or steps, pertaining to an example embodiment can be combined with one or more aspects, or steps, of other embodiments to create new embodiments still within the scope of the present invention. Therefore, persons of ordinary skill in the art would appreciate that various embodiments of the present invention may incorporate aspects from other embodiments, or may be implemented in combination with other embodiments.

### DESCRIPTION OF DRAWINGS

The invention will be further understood from the following description of various example embodiments, taken in conjunction with appended drawings, in which:

FIG. 1 discloses example apparatuses, systems, configurations, etc. that may be utilized when implementing the various embodiments of the present invention

FIG. 2 discloses further detail regarding an example apparatus configuration that may be utilized when implementing the various embodiments of the present invention.

FIG. 3 discloses the example levels of a wireless communication architecture in accordance with at least one embodiment of the present invention.

FIG. 4 discloses an example of services being utilized to create service nodes on a billboard in accordance with at least one embodiment of the present invention.

FIG. 5 discloses an example Network on Terminal Architecture in accordance with at least one embodiment of the present invention.

FIG. 6 discloses an example transport table in accordance with at least one embodiment of the present invention.

FIG. 7 discloses an example of the types of information that may be exchanged between various layers in a Network on Terminal Architecture in accordance with at least one embodiment of the present invention

FIG. 8 discloses an example of communication to a billboard utilizing a connection map in accordance with at least one embodiment of the present invention.

FIG. 9 discloses an example of a plurality of apparatuses interacting utilizing different transports selected in accordance with at least one embodiment of the present invention.

FIG. 10 discloses a flowchart of an example communication configuration process in an apparatus wherein a transport may be selected for use in transmitting pending messages in accordance with at least one embodiment of the present invention.

### DESCRIPTION OF EXAMPLE EMBODIMENTS

While the invention has been described below in terms of a multitude of example embodiments, various changes can be made therein without departing from the spirit and scope of the invention, as described in the appended claims.

I. Example System with Which Embodiments of the Present Invention may be Implemented

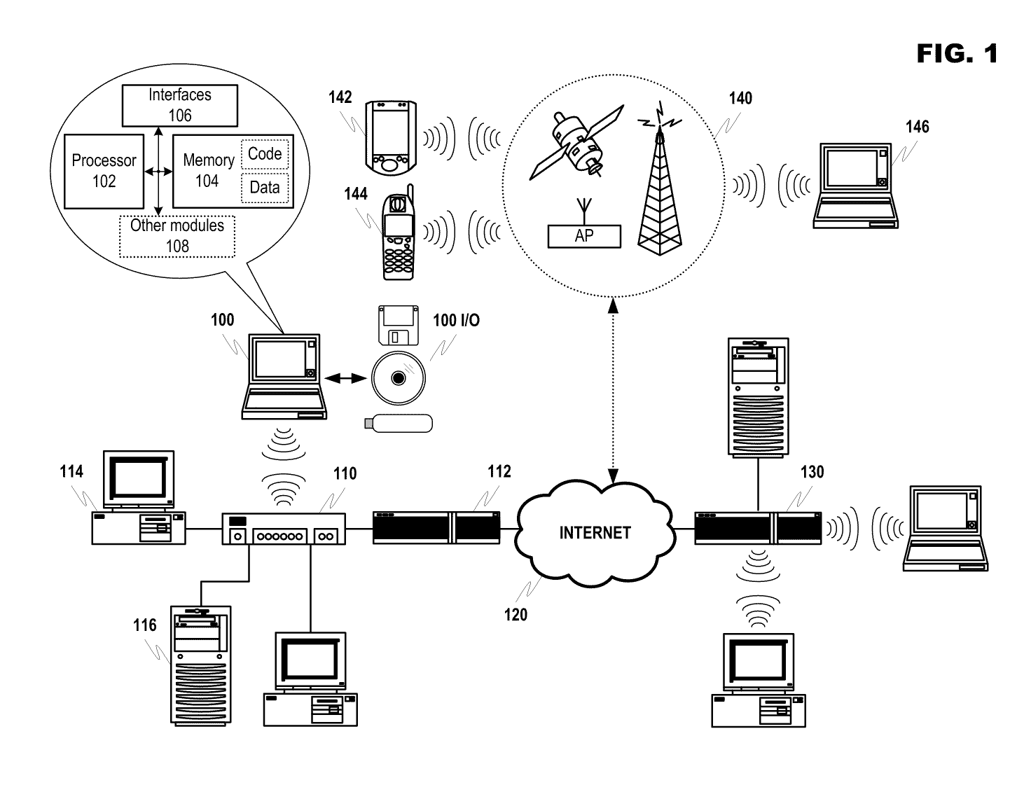

An example of a system that is usable for implementing various embodiments of the present invention is disclosed in FIG. 1. The system comprises elements that may be included in, or omitted from, configurations depending, for example, on the requirements of a particular application, and therefore, is not intended to limit present invention in any manner.

Computing device 100 may correspond to various processing-enabled apparatuses including, but not limited to, micro personal computers (UMPC), netbooks, laptop computers, desktop computers, engineering workstations, personal digital assistants (PDA), computerized watches, wired or wireless terminals/nodes/etc., mobile handsets, set-top boxes, personal video recorders (PVR), automatic teller machines (ATM), game consoles, or the like. Elements that represent basic example components comprising functional elements in computing device 100 are disclosed at 102-108. Processor 102 may include one or more devices configured to execute instructions. In at least one scenario, the execution of program code (e.g., groups of computer-executable instructions stored in a memory) by processor 102 may cause computing device 100 to perform processes including, for example, method steps that may result in data, events or other output activities. Processor 102 may be a dedicated (e.g., monolithic) microprocessor device, or may be part of a composite device such as an ASIC, gate array, multi-chip module (MCM), etc.

Processor 102 may be electronically coupled to other functional components in computing device 100 via a wired or wireless bus. For example, processor 102 may access memory 102 in order to obtain stored information (e.g., program code, data, etc.) for use during processing. Memory 104 may generally include removable or imbedded memories that operate in a static or dynamic mode. Further, memory 104 may include read only memories (ROM), random access memories (RAM), and rewritable memories such as Flash, EPROM, etc. Examples of removable storage media based on magnetic, electronic and/or optical technologies are shown at 100 I/O in FIG. 1, and may serve, for instance, as a data input/output means. Code may include any interpreted or compiled computer language including computer-executable instructions. The code and/or data may be used to create software modules such as operating systems, communication utilities, user interfaces, more specialized program modules, etc.

One or more interfaces 106 may also be coupled to various components in computing device 100. These interfaces may allow for inter-apparatus communication (e.g., a software or protocol interface), apparatus-to-apparatus communication (e.g., a wired or wireless communication interface) and even apparatus to user communication (e.g., a user interface). These interfaces allow components within computing device 100, other apparatuses and users to interact with computing device 100. Further, interfaces 106 may communicate machine-readable data, such as electronic, magnetic or optical signals embodied on a computer readable medium, or may translate the actions of users into activity that may be understood by computing device 100 (e.g., typing on a keyboard, speaking into the receiver of a cellular handset, touching an icon on a touch screen device, etc.) Interfaces 106 may further allow processor 102 and/or memory 104 to interact with other modules 108. For example, other modules 108 may comprise one or more components supporting more specialized functionality provided by computing device 100.

Computing device 100 may interact with other apparatuses via various networks as further shown in FIG. 1. For example, hub 110 may provide wired and/or wireless support to devices such as computer 114 and server 116. Hub 110 may be further coupled to router 112 that allows devices on the local area network (LAN) to interact with devices on a wide area network (WAN, such as Internet 120). In such a scenario, another router 130 may transmit information to, and receive information from, router 112 so that devices on each LAN may communicate. Further, all of the components depicted in this example configuration are not necessary for implementation of the present invention. For example, in the LAN serviced by router 130 no additional hub is needed since this functionality may be supported by the router.

Further, interaction with remote devices may be supported by various providers of short and long range wireless communication 140. These providers may use, for example, long range terrestrial-based cellular systems and satellite communication, and/or short-range wireless access points in order to provide a wireless connection to Internet 120. For example, personal digital assistant (PDA) 142 and cellular handset 144 may communicate with computing device 100 via an Internet connection provided by a provider of wireless communication 140. Similar functionality may be included in devices, such as laptop computer 146, in the form of hardware and/or software resources configured to allow short and/or long range wireless communication.

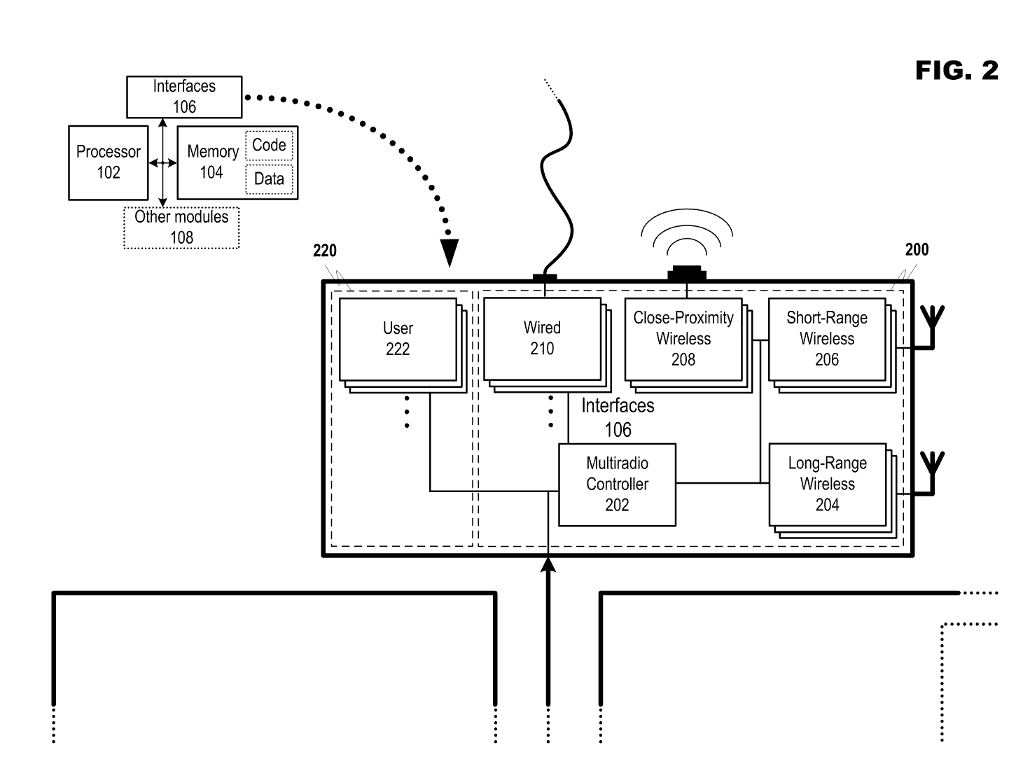

Further detail regarding example interface component 106, shown with respect to computing device 100 in FIG. 1, is now discussed with respect to FIG. 2. Initially, interfaces such as disclosed at 106 are not limited to use only with computing device 100, which is utilized herein only for the sake of explanation. As a result, interface features may be implemented in any of the apparatuses that are disclosed in FIG. 1 (e.g., 142, 144, etc.) As previously set forth, interfaces 106 may include interfaces both for communicating data to computing apparatus 100 (e.g., as identified at 200) and other types of interfaces 220 including, for example, user interface 222. A representative group of apparatus-level interfaces is disclosed at 200. For example, multiradio controller 202 may manage the interoperation of long range wireless interfaces 204 (e.g., cellular voice and data networks), short-range wireless interfaces 206 (e.g., Bluetooth and WLAN networks), close-proximity wireless interfaces 208 (e.g., for interactions where electronic, magnetic, electromagnetic and optical information scanners interpret machine-readable data), wired interfaces 210 (e.g., Ethernet), etc. The example interfaces shown in FIG. 2 have been presented only for the sake of explanation herein, and thus, are not intended to limit the various embodiments of the present invention to utilization of any particular interface. Embodiments of the present invention may also utilize interfaces that are not specifically identified in FIG. 2.

Multiradio controller 202 may manage the operation of some or all of interfaces 204-210. For example, multiradio controller 202 may prevent interfaces that could interfere with each other from operating at the same time by allocating specific time periods during which each interface is permitted to operate. Further, multiradio controller 202 may be able to process environmental information, such as sensed interference in the operational environment, to select an interface that will be more resilient to the interference. These multiradio control scenarios are not meant to encompass an exhaustive list of possible control functionality, but are merely given as examples of how multiradio controller 202 may interact with interfaces 204-210 in FIG. 2.

### II. Example Network on Terminal (NoTA) Architecture.

In accordance with at least one embodiment of the present invention, emerging services that may be provided in apparatuses capable of wired and/or wireless communication may comprise communication-related features that are deliberately designed to be transport-independent. Designing services in this manner takes the burden of communication management off of the application and assigns it to the operating environment in which the service is running. This may allow, for example, services to be distributed to apparatuses regardless of the particular communication configuration of the apparatus, reducing the need for apparatus-specific versions.

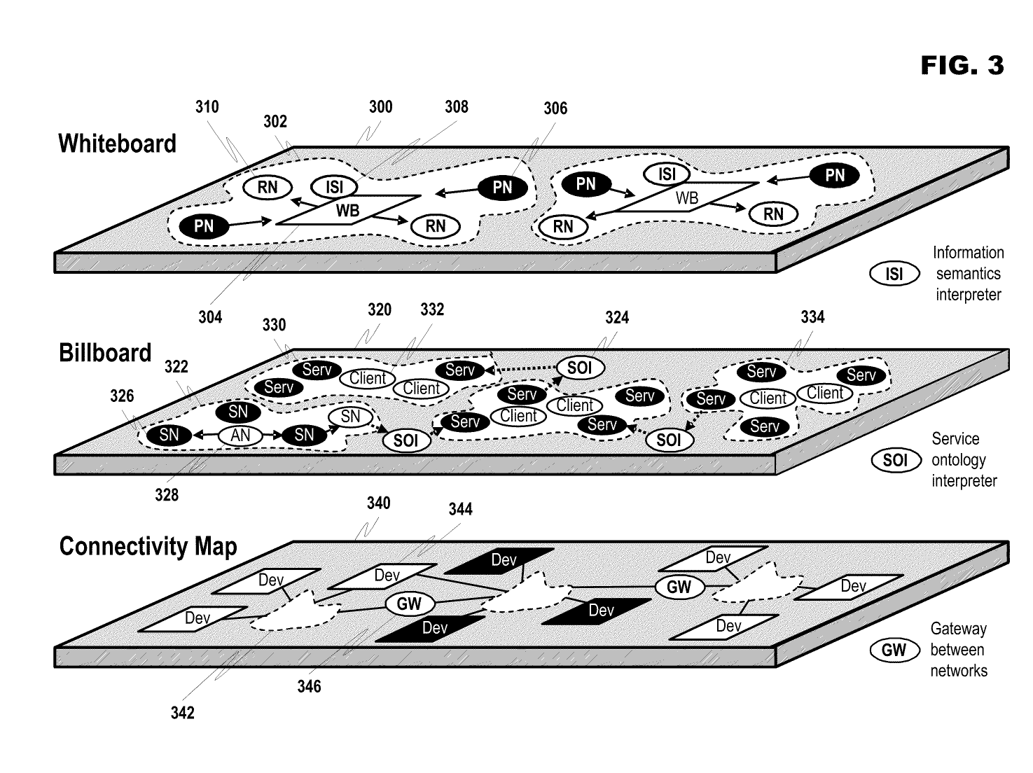

Network on Terminal Architecture (NoTA) is an example operating environment that, in accordance with at least one embodiment of the present invention, possesses transport-independent characteristics such as described above. Whiteboard 300 is disclosed in FIG. 3 as one possible example of an NoTA service. At this level, operational groups 302 may be formed including whiteboards 304 and various application nodes. Application nodes may correspond to various applications existing on a plurality of apparatuses, and may be utilized to exchange information between these applications, for example, by placing data into, and removing data from, whiteboard 304. For example, the types of nodes may comprise proactive nodes (PN) 306 that are utilized to place information into whiteboard 304, reactive nodes (RN) 310 are utilized to take information from whiteboard 304. Information semantics interpreter (ISI) 308 may link different whiteboards together. Utilizing such constructs, Whiteboard 304 may provide a means for standardizing application interaction that overcomes incompatibilities.

Billboard level 320 facilitates interaction between services available on devices participating in NoTA. For instance, Billboard level 320 provides sharing of service-related information (e.g., service identification information, functionality, etc.), as well as information that may be necessary when accessing and/or utilizing each service. Services 330 and clients 332 that may utilize these services may be organized in service domains 322. In at least one scenario, service domains 322 may each correspond to a particular protocol, such as Universal Plug and Play (UPnP), Bluetooth Service Discovery Protocol (BT SDP), Bonjour, etc. In each service domain 322, services 330 may be represented by service nodes (SN) 326, and likewise, application nodes (AN) 328 may correspond to applications. Further, service domains 322 may interact utilizing service ontology interpreters (SOI) 324. SOI 324 allows service domains 322 to interact with other service domains 334 in the service level, even if service domains 322 reside on different apparatuses (e.g., to provide access information to other service domains 322).

Connectivity map 340 may define available connection methods, possible routing methods and topology for the apparatuses that are communicating using an NoTA interconnect. In accordance with at least one embodiment of the present invention, devices 344 may be linked in directly connected groups 342. Examples of directly connected groups (Dev) 342 may include devices connected via wired Ethernet links, wired Universal Serial Bus links, wireless Bluetooth piconets, wireless local area networks (WLAN), wireless Universal Serial Bus (wUSB) links, etc. Each directly connected group of devices 342 may further be linked by gateways (GW) 346.

### III. Service Node Implementation

Services may be defined as functionality offered and/or derived from software programs. Services can pertain to all aspects of device functionality and can be provided, for example, by an operating system loaded on an apparatus, or alternatively, may be added to the apparatus by separate software programs related to communication, security, productivity, device resource management, entertainment, etc. According to at least one embodiment of the present invention, service nodes may represent services available on the apparatuses linked by NoTA.

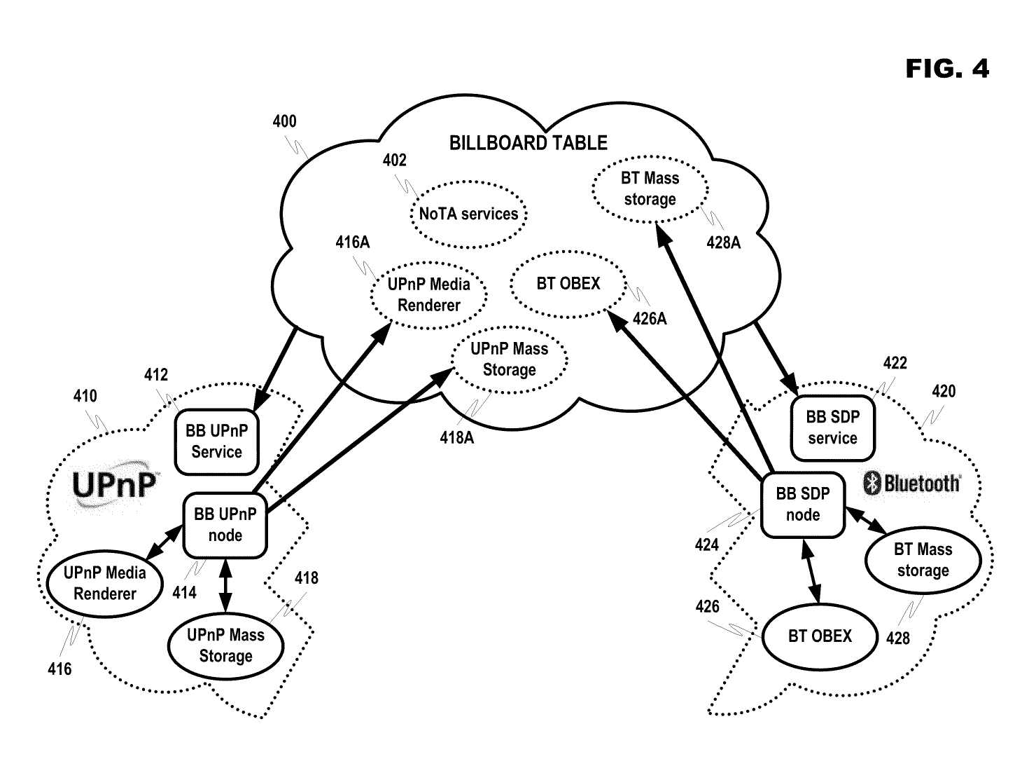

FIG. 4 discloses an example of billboard functionality in accordance with at least one embodiment of the present invention. Billboard 400 may comprise a shared memory space established amongst one or more wired or wireless apparatuses. The scenario disclosed in FIG. 4 may further include a protocol such as UPnP 410 installed on an apparatus, and Bluetooth SDP 420 installed on another apparatus. Billboard 400 may interact with these protocols using one or more services installed in the apparatuses, such as example billboard services BB UPnP service 412 and BB SDP service 422. BB services 412 and 422 are typically components of UPnP and BT architecture, but they can also be representative components provided as part of the NoTA.

UPnP 410 may offer services locally to the apparatus on which it is installed. Example services may include UPnP media renderer service 416 and UPnP mass storage service 418. Similarly, in the example of FIG. 4 Bluetooth SDP 420 may provide BT OBEX service 426 and BT mass storage service 428 on a separate apparatus. The particular UPnP and BT services identified in FIG. 4 have been selected only for the sake of example herein, and are not intended to limit the scope of services usable with embodiments of the present invention. While services are normally only accessible to applications residing in the same service domain, NoTA may facilitate interaction between various services and/or applications, regardless of access method. For example, while interaction between different service domains is not specifically defined, service information and access methods can still be shared between domains utilizing NoTA.

At least one embodiment of the present invention may operate by creating service information entries corresponding to services offered on each device in billboard table 400. In the scenario disclosed in FIG. 4, BB UPnP node 414 and BB SDP node 424 may create service information entries UPnP media renderer service 416A and UPnP mass storage service 418A, as well as BT OBEX service 426A and BT mass storage service 428A, respectively. These service information entries may all exist in a common billboard table 400, despite the actual protocols and services residing on separate devices. Further, the service information entries may provide information about services to other services and/or applications, such as the name of the service, service properties, pairing & authentication information utilized in accessing a particular service and/or transport mediums usable with each service. This service information may be obtained, for example, via BB SDP service 424 if billboard table 400 is accessed from the BT domain, or BB UPnP 414 service if billboard table 400 is accessed from the UPnP domain. In architectures such as NoTA, it may also be possible to provide direct access to billboard services. NoTA services 402 may, in accordance with at least one embodiment of the present invention, establish initial communication between participating apparatuses via a common wireless communication transport in order to establish a shared memory space that will be utilized as Billboard table 400.

### IV. Example of Underlying Architecture

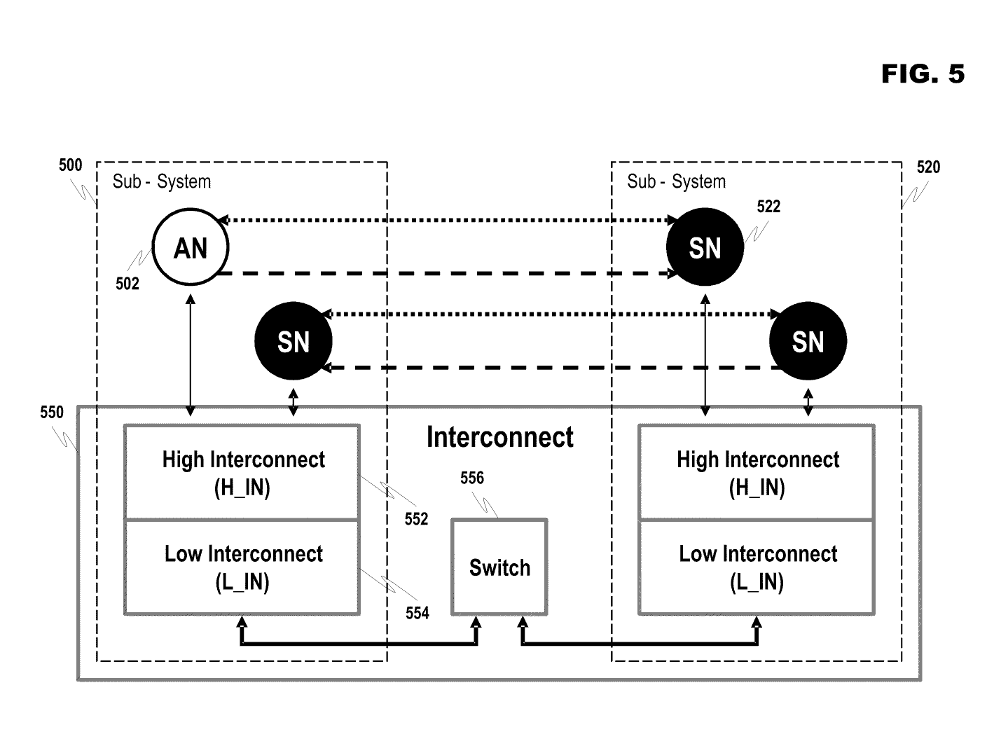

FIG. 5 discloses an example of an underlying logical architecture that may be utilized in implementing NoTA. NoTA may be configured as multiple subsystems (e.g., 500 and 520) coupled by interconnect 550. NoTA interconnect 550 may comprise two layers: High Interconnect (H_IN) layer 552 and Low Interconnect (L_IN) layer 554 that are coupled by switch 556. Low interconnect layer 554 may include ISO/OSI layers L1-L4 and may provide transport socket type interface upwards. One or both of these layers may be deemed middleware in that they comprise one or more software modules that may couple software components or applications within an apparatus (or between apparatuses in the instance of a network). For example, High Interconnect layer 552 may act as middleware between L_IN 554 and the higher level Application nodes (AN) 502 and Service nodes (SN) 522 residing in subsystems 500 and 520, respectively. H_IN 552 functionality may provide client nodes (AN 502 or SN 522) direct access to services (without having to disclose the location of the latter). Likewise, L_IN 554 may also be considered middleware that provides transparent access to communication transports for upper level functionality (e.g., transport-independent message routing for application and H-IN layers). Communication may be connection-oriented, meaning that before any service or data communication takes place, connection setup procedures would need to be carried out. Security features may also be added to countermeasure identified threats. As set forth in the example of FIG. 5, NoTA may provide intra-device service access making it possible to build independent subsystems providing both services and applications. Moreover, example implementations may include several individual NoTA devices involved in direct inter sub-system communication.

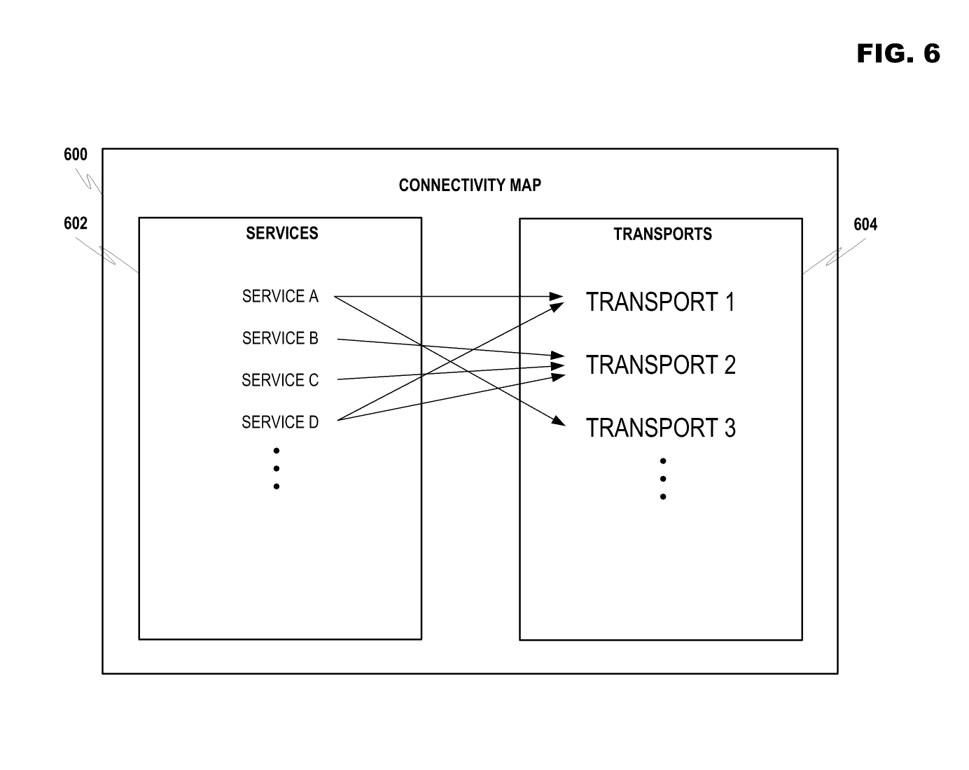

FIG. 6 discloses another structure that may be implemented in accordance with various embodiments of the present invention. Connectivity map 600 may associate services available on apparatuses participating in billboard table 400 with communication transports that may be utilized in conjunction with each service. Examples of communication transports may include, but are not limited to, wireless communication mediums such as Bluetooth, WLAN, Bluetooth Low Energy (BTLE), wUSB, etc. In addition, at least one embodiment of the present invention may also apply radio technologies to different protocols (e.g., Bluetooth protocols may be implemented over WLAN). However, the various embodiments the present invention are not specifically limited to using these particular communication transports, and may be implemented with other wired or wireless communication mediums that are usable by services offered by various participating apparatuses. Services (e.g., offered by apparatuses) in FIG. 6 may be listed under services 602, and the corresponding available transports are listed under transports 604. Arrows between services 602 and transports 604 indicate the one or more transport mediums that are usable by each service. Information in connectivity map 600 may, in accordance with various embodiments of the present invention, bind billboard table content (e.g., service offerings) and available apparatus connectivity configuration. This information may be utilized, for example, by applications when determining the communication transports that are usable with a particular service. Where two or more transport mediums are usable, a particular communication medium may ultimately be selected based on characteristics such as speed, traffic, priority of executing the service, other active wireless communication mediums, etc.

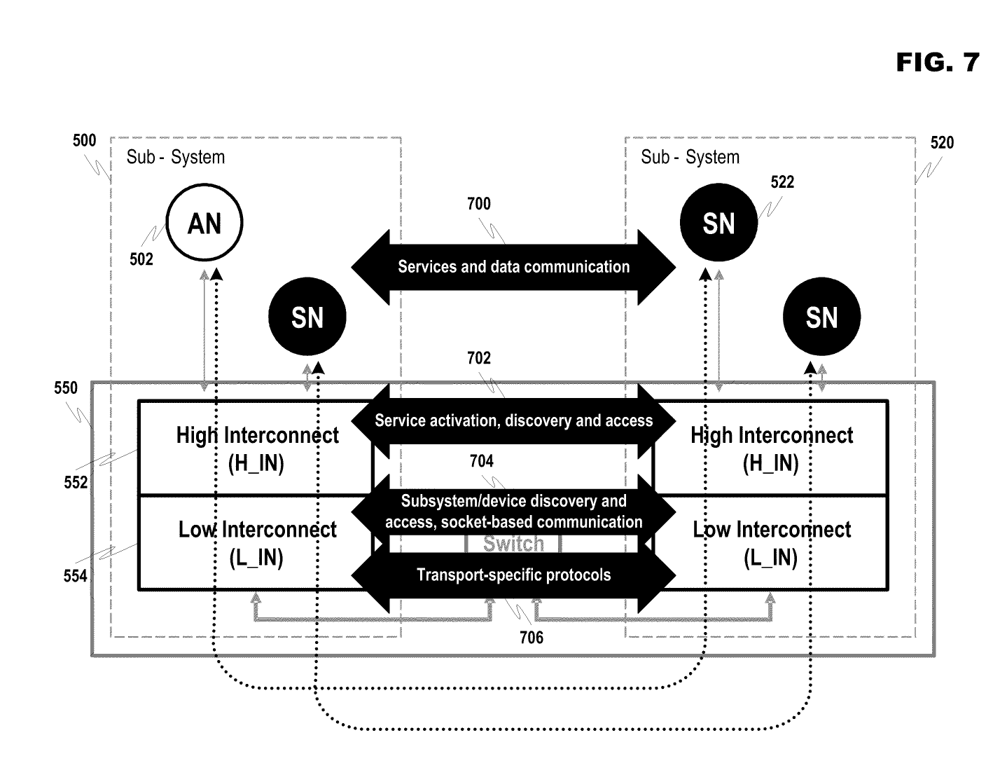

Now referring to FIG. 7, example message types that correspond to information that may be exchanged at various levels of an operational environment like NoTA is disclosed. Service and data-related information 700 may be the end result of communication triggered by interactivity between application nodes 502 and service nodes 522. For example, information may be desired and/or required by an application, and as such, may be requested from services residing on other apparatuses that are also participating in the NoTA. However, in order to arrive at the ultimate result wherein the desired and/or required information is provided to the consuming application, some underlying messaging related to control must first be executed so that desired and/or required information may be located, connections may be established, etc.

For example, service activation, discovery and access information 702 may be exchanged in at H_IN level 552. The messages exchanged at 702 may be the result of a service or data access request from an application node, and may include billboard search activities that may query other apparatuses for the data and/or services that are desired/required. The queries for resources may further be supported by subsystem/device discovery and access, socket-based communication 704. This level of communication in operational environments may serve as the interface between transport-independent activities and the actual communication that may be employed in supporting the required interaction. More specifically, the messaging interaction taking place at 700 and 702 may be transport independent, and thus, the requirements are simply requests for access to resources that may reside on another apparatus. The messaging taking place at 704 may evaluate the message requirements that were created at 700 and 702 and assign them to one or more transport-specific protocols 704 for actual execution. The messaging taking place at 704 may comprise determinations as to the protocols that may be utilized for executing the desired transaction, as well as the selection of the most appropriate protocols for performing the transaction based on the nature of the communication, apparatus condition, environment, etc.

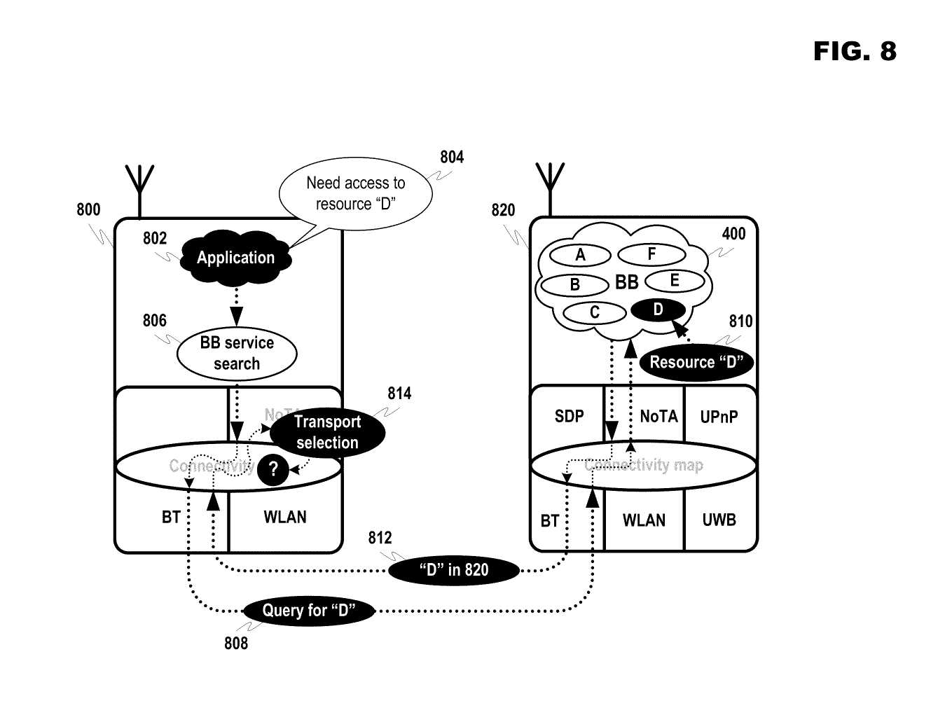

FIG. 8 discloses an example wherein apparatuses 800 and 820 are interacting via an operational environment like NoTA. While only two apparatuses have been disclosed in FIG. 8 for the sake of explanation herein, the various embodiments of the present invention are not limited to use with only two apparatuses. Interaction in this scenario may be initiated by any participating apparatus, but in the disclosed example is triggered by application 802 in apparatus 800. Application 802 may be, for example, a software/ program module that upon activation, execution or user interaction creates requirements to access a resource (e.g., as shown at 804).

BB search 806 may utilize a transport, such as Bluetooth (BT), to perform query 808 of available resources in the NoTA environment. The same transport may further be used to exchange connectivity map information, which may eventually be utilized in transport selection 814 when appropriate transports are to be selected. The accumulation of this available resource information may help facilitate the identification of potential providers for requested resources, such as resource “D” requested by application 802. For example, information in BB 400 may disclose that resource “D” 810 actually resides on apparatus 820 in the NoTA environment, and therefore, apparatus 820 is capable of acting as a “provider” for resource “D” to apparatus 800.

A response 812 to inquiry 808 may be returned identifying one or more potential resources (e.g., services, databases, etc.) residing on at least one provider (in this case apparatus 820). However, subsequent transactions cannot be limited to utilizing the transport that was initially selected in order to perform the query. For example, high speed, low power, low throughput transports like Bluetooth Low Energy (BTLE) may be adequate for performing initial queries, but would not be likewise appropriate for further interaction if large amounts of data are to be conveyed, a low error rate is required or other similar requirements exist. Therefore, at 814 a determination may be made as to maintain the current transport or to select a new transport.

V. Example of Transport Selection Based upon Message Type.

In accordance with at least one embodiment of the present invention, transport-independent interaction may be facilitated by lower layer communication control elements that transparently allocate communication resources for supporting these access requirements. For instance, communication resources may be configured based on the type of communication that is queued for transmission. As described with respect to FIG. 7, two example message types are control-type messages and data-type messages. Control-type messages may directed to various support activities within the operational environment such as establishing and maintaining wired and/or wireless connections, communicating apparatus-related information such as identification, status and available resource information, querying, selecting and accessing resources located on remote apparatuses, etc. These types of messages may be considered to be communicated using connectionless (CL) links. Data-type messages may then comprise information that is conveyed as a result of the activities conducted using control-type messages. This information may comprise the outputs of various services, stored file information, streamed multimedia information, etc. As a result of the more formal communication configuration involved in conveying this type of information, data-type messages are often considered to be communicated using connection oriented (CO) links.

In view of the example message types set forth above, it is readily apparent that control-type messages will often contain relatively small, fixed-size control frame structures that may be sent in a single transmission, while data-type messages may involve substantially larger transactions that may span multiple transmissions (e.g., depending on the amount of information being requested). Therefore, data-type messages may comprise different delivery requirements such as a minimum Quality of Service (QoS) that can only be delivered by certain speed, data capacity and error correction conditions Likewise, communication configurations for control-type messages and data-type messages may be significantly different. The choice of a transport for control-type messages may not be as critical since the QoS will not be as rigid as in data-type messages, and thus, communication transports that are lower speed and/or capacity, but that also use less power, may be used in order to conserve resources in an apparatus. On the other hand, data-type messages may require a more robust transport in order to ensure a minimum QoS level.

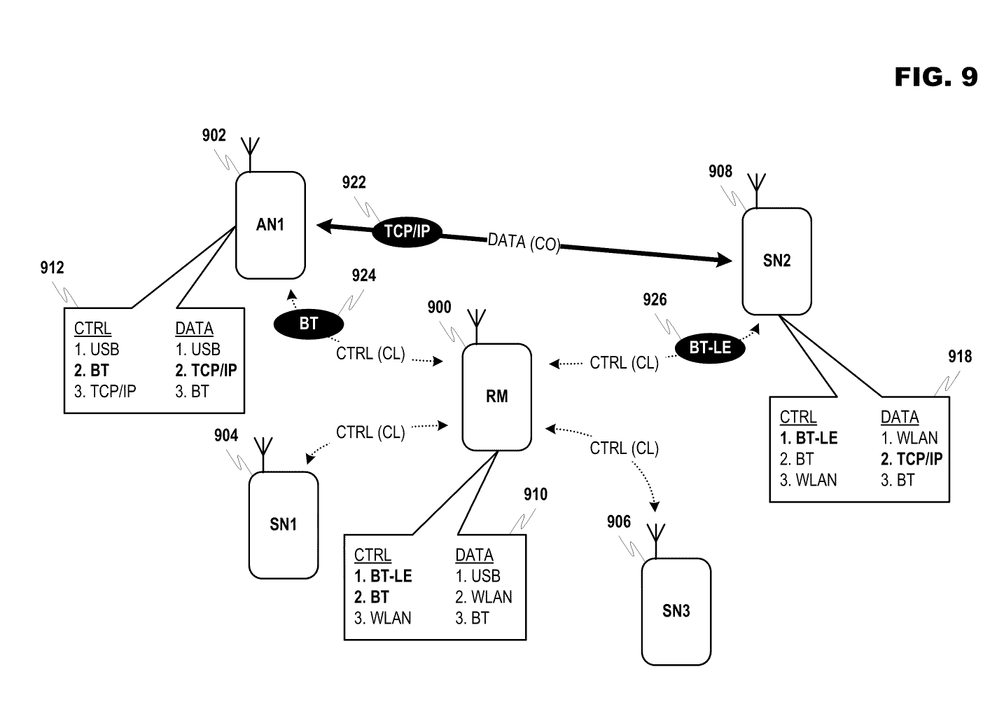

Various example implementations of the present invention may utilize message type as a criteria to configure communications in an apparatus. Such a practice does not interfere with transport-independence since communication configuration continues to be handled by the lower levels of the operational environment (e.g., NoTA), which maintains transparency for the upper levels. Example interactivity that explains how at least one embodiment of the present invention may function is disclosed in FIG. 9. Apparatuses 902-908 may interact via NoTA. Each of these apparatuses may contain nodes (e.g., Application nodes, AN, or Service Nodes, SN), and at least one apparatus may include a resource manager (RM) that tracks connectivity information for each apparatus. In collecting this information, the RM in apparatus 900 may receive control-type messages from each of apparatuses 902-908. The apparatuses may utilize these connectionless links to convey apparatus condition, communication abilities, available service information, sensed interferences in the operating environment, etc. The apparatuses may later establish connection oriented links for communicating data-type messages, wherein these links may be established directly between consuming apparatus and providing apparatus.

Each apparatus may further comprise transport sets including one or more wired and/or wireless communication transports. Example transport sets are disclosed in FIG. 9 at 910, 912 and 918. There may be multiple transports sets in each apparatus corresponding to various criteria, for example, corresponding to each of the previously described message types, and the communication transports in each transport set may be arranged in a priority order. Priority may be established based on parameters pertaining to the consuming application/providing service, the consuming apparatus/providing apparatus or may be based on the operational environment. Moreover, the relative priority of the communication transports in each transport set may be altered to changes at the application, apparatus or network level. For example, the unavailability of transports (e.g., no wired network connection being available) may remove a transport from a transport set, while heavy traffic loading may result in the priority for a transport being reduced. On the other hand, the QoS requirements for a connection or other conditions currently existing in an apparatus (e.g., power level) may cause priority of certain transports to be increased.

An example of how various embodiments of the present invention may operate is disclosed in FIG. 9 by the interaction between apparatuses 900, 902 and 908. Apparatus 900 has a control-type message transport set and a data-type transport set as disclosed at 910. Apparatus 902 may desires to communicate control-type information to the RM in apparatus 900, and may give the highest priority to USB for control type messages per 912. However, USB interactivity is not supported in apparatus 900. Therefore, control elements for both apparatuses 910 and 912 that exist in lower communication layers (e.g., L_IN 554) may select the next highest priority communication transport, which is Bluetooth (BT) 924, for use in control-type messaging. It may also be possible for different apparatuses to utilize transport sets that prioritize transports in a conflicting manner, such as one apparatus having BT prioritized above USB, and the other apparatus having these transports prioritized in the opposite order. These conflicts may be resolved on a case-by-case basis in view of apparatus-level or network-level operational rules.

In a similar fashion, apparatus 908 may desire to exchange control-type messages with the RM in apparatus 900. However, in this instance both apparatuses support Bluetooth Low Energy (BT-LE) communication, and have prioritized this transport above other available transports per transport sets 910 and 918. BT-LE may then be utilized by both apparatuses as disclosed at 926, and some benefit due to resource conservation (e.g., power saving) may be realized in both apparatuses. Some or all of the information collected by the RM in apparatus 900 may be utilized to query desired and/or required resources that may exist in the operational environment. For example, the results of billboard service search 806 may indicate that a service corresponding to SN2 required by an application corresponding to AN1 on apparatus 902 resides on apparatus 908. As a result, a connection oriented link may be established between these two apparatuses for conveying data-type messages. Apparatus 902 prioritizes USB highest, but such connections may not be supported by apparatus 908. Likewise, apparatus 902 may not support WLAN links. As a result, both apparatuses may proceed down the priority list established in their respective protocol sets until a common transport is identified. In this instance, TCP/IP is supported by both apparatuses, and so a link for conveying data-type messages that utilizes this communication protocol is established at 922. Again, the relative priority of protocols listed in each protocol set may change due to application, apparatus or operating environment changes, and any conflicts in prioritization experienced between the apparatuses may be resolved on a case-by-case basis in view of rules established at the apparatus-level or the network level.

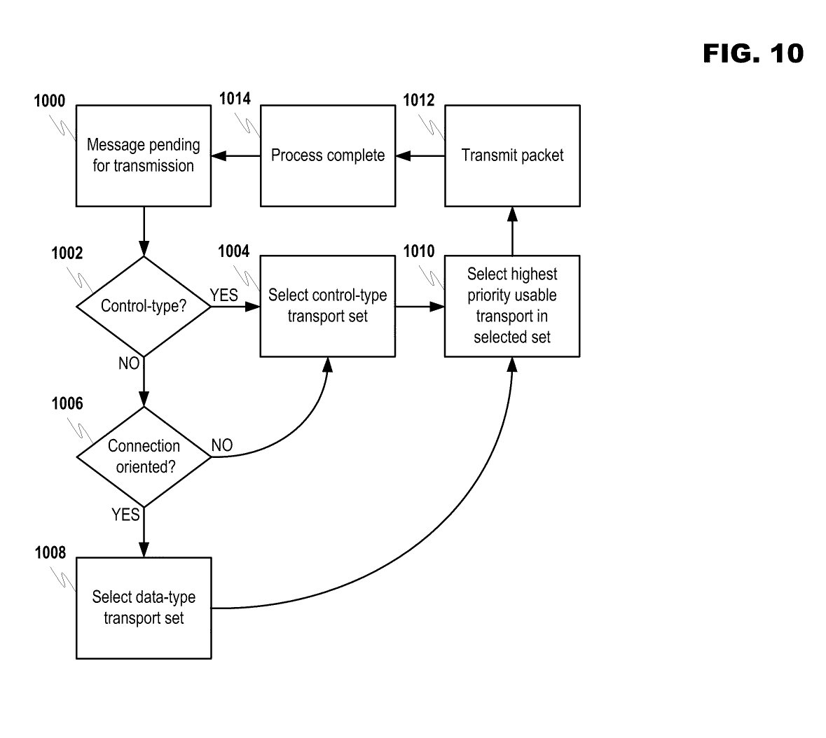

A flowchart of an example process in accordance with at least one embodiment of the present invention is disclosed in FIG. 10. A message pending transmission in an apparatus may be identified in step 1000. A determination may then be made in step 1002 as to whether the message is a control-type message. If the pending message is determined to be a control-type message, the in step 1004 a transport set for use with control-type messages may be selected. If the message is not a control type message, then in step 1006 a determination may be made as to whether the pending message is a connection oriented message. For example, it may be possible for some data-type messages to be short enough for conveyance using a connectionless link, and thus, a transport set for use with control-type messages may still be selected in step 1004. For information that may comprise multiple messages, or that requires transmission with a minimum QoS, a connection oriented link may be deemed to be required in step 1006. In such instances, a transport set for use with data-type messages may be selected in the in apparatus in step 1008.

Regardless of whether a control-type transport set is selected in step 1004, or alternatively, a data-type transport set is selected in step 1008, the process may then proceed to step 1010 where the highest priority usable transport is selected based on the transport sets in both the transmitting and receiving apparatuses. The highest priority usable transport may be a transport that is supported in both the transmitting and receiving apparatuses (e.g., included in the selected transport set of both apparatuses) having the highest priority. While the priority of a particular transport may be listed with higher priority in one apparatus vs. another apparatus, any conflicts existing in the apparatuses may be resolved on a case-by-case basis based on apparatus-level or network-level rules governing apparatus interaction. Interactivity rules may be flexibly managed by, for example, a resource manager in the operational environment and may analyze criteria such as the requirements of the pending message, apparatus condition, communication traffic, sensed interference in the operational environment, etc. when resolving communication conflicts. After a communication transport is selected in step 1010, the pending message may be transmitted in step 1012. The process may then terminate in step 1014 and return to step 1000 in preparation for the next message that is identified as pending for transmission in the apparatus.

The various embodiments of the present invention are not limited only to the examples disclosed above, and may encompass other configurations or implementations.

For example, example embodiments of the present invention may encompass apparatuses comprising means for transmitting a wireless query from an apparatus, means for receiving responses to the wireless query from other apparatuses, means for determining if any of the responses identify a responding apparatus as a service information holding apparatus configured to maintain service information related to the other apparatuses in addition to service information related to the responding apparatus, means for, if a response identifies a service information holding apparatus, transmitting a service information request to the service information holding apparatus, and means for receiving a response to the service information request, the response including service information related to one or more other apparatuses in addition to the service information holding apparatus.

At least one other example embodiment of the present invention may include apparatuses comprising means for receiving wireless messages from other apparatuses at a service information holding apparatus, means for determining if the received wireless messages include service discovery requests, means for, if the received wireless messages include service discovery requests, transmitting responses to the service discovery requests, the responses including at least local service and non-local service information, and means for, if the received wireless messages do not include service discovery requests, transmitting service information requests to apparatuses corresponding to the received wireless messages and storing service information received in response to the service information requests.

At least one other example embodiment of the present invention may include electronic signals that cause apparatuses to transmit a wireless query from an apparatus, receive responses to the wireless query from other apparatuses, determine if any of the responses identify a responding apparatus as a service information holding apparatus configured to maintain service information related to the other apparatuses in addition to service information related to the responding apparatus, if a response identifies a service information holding apparatus, transmit a service information request to the service information holding apparatus, and receive a response to the service information request, the response including service information related to one or more other apparatuses in addition to the service information holding apparatus.

At least one other example embodiment of the present invention may include electronic signals that cause apparatuses to receive wireless messages from other apparatuses at a service information holding apparatus, determine if the received wireless messages include service discovery requests, if the received wireless messages include service discovery requests, transmit responses to the service discovery requests, the responses including at least local service and non-local service information, and if the received wireless messages do not include service discovery requests, transmit service information requests to apparatuses corresponding to the received wireless messages and storing service information received in response to the service information requests.

Accordingly, it will be apparent to persons skilled in the relevant art that various changes in forma and detail can be made therein without departing from the spirit and scope of the invention. The breadth and scope of the present invention should not be limited by any of the above-described example embodiments, but should be defined only in accordance with the following claims and their equivalents.

What is claimed:

1. A method, comprising:
identifying a message in an apparatus to be transmitted via a transport-independent communication architecture;
determining a message type corresponding to the message;
selecting a transport set based on the determined message type, the transport set comprising one or more communication transports that are supported in the apparatus;
selecting at least one transport from the selected transport set for transmitting the message; and
transmitting the message using the selected transport.

2. The method of claim 1, wherein determining a message type comprises determining whether the message is a control-type message or a data-type message.

3. The method of claim 1, wherein selecting a transport set comprises selecting a set of transports for control-type messages or a set of transports for data-types messages.

4. The method of claim 3, wherein the set of transports for control-type messages and the set of transports for data-type messages each comprise a prioritized list of transports.

5. The method of claim 4, wherein the list of transports are prioritized based on operational characteristics of the transports compared to at least one of the condition of the apparatus, the environment in which the apparatus is operating or network-related information.

6. The method of claim 4, wherein selecting at least one transport comprises selecting a usable transport having the highest priority from the selected transport set, the usable transports in the selected transport list comprising transports that are supported by both the apparatus and one or more other apparatuses intended as recipients of the message.

7. The method of claim 1, wherein the method is executed by a lower level data routing layer, the lower level data routing layer forming a middleware layer in the apparatus.

8. A computer program product comprising computer executable program code recorded on a computer readable storage medium, the computer executable program code comprising:
code configured to cause an apparatus to identify a message to be transmitted via a transport-independent communication architecture;
code configured to cause an apparatus to determine a message type corresponding to the message;
code configured to cause an apparatus to select a transport set based on the determined message type, the transport set comprising one or more communication transports that are supported in the apparatus;
code configured to cause an apparatus to select at least one transport from the selected transport set for transmitting the message; and
code configured to cause an apparatus to transmit the message using the selected transport.

9. The computer program product of claim 8, wherein determining a message type comprises determining whether the message is a control-type message or a data-type message.

10. The computer program product of claim 8, wherein selecting a transport set comprises selecting a set of transports for control-type messages or a set of transports for data-types messages.

11. The computer program product of claim 10, wherein the set of transports for control-type messages and the set of transports for data-type messages each comprise a prioritized list of transports.

12. The computer program product of claim 11, wherein the list of transports are prioritized based on operational characteristics of the transports compared to at least one of the condition of the apparatus, the environment in which the apparatus is operating or network-related information.

13. The computer program product of claim 11, wherein selecting at least one transport comprises selecting a usable transport having the highest priority from the selected transport set, the usable transports in the selected transport list comprising transports that are supported by both the apparatus and one or more other apparatuses intended as recipients of the message.

14. The computer program product of claim 8, wherein the method is executed by a lower level data routing layer, the lower level data routing layer forming a middleware layer in the apparatus.

15. An apparatus, comprising:
at least one processor; and
at least one memory including executable instructions, the at least one memory and the executable instructions being configured to, in cooperation with the at least one processor, cause the device to perform at least the following:
identify a message to be transmitted via a transport-independent communication architecture;
determine a message type corresponding to the message;
select a transport set based on the determined message type, the transport set comprising one or more communication transports that are supported in the apparatus;
select at least one transport from the selected transport set for transmitting the message; and
transmit the message using the selected transport.

16. The apparatus of claim 15, wherein determining a message type comprises determining whether the message is a control-type message or a data-type message.

17. The apparatus of claim 15, wherein selecting a transport set comprises selecting a set of transports for control-type messages or a set of transports for data-types messages.

18. The apparatus of claim 17, wherein the set of transports for control-type messages and the set of transports for data-type messages each comprise a prioritized list of transports.

19. The apparatus of claim 18, wherein the list of transports are prioritized based on operational characteristics of the transports compared to at least one of the condition of the apparatus, the environment in which the apparatus is operating or network-related information.

20. The apparatus of claim 18, wherein selecting at least one transport comprises selecting a usable transport having the highest priority from the selected transport set, the usable transports in the selected transport list comprising transports that are supported by both the apparatus and one or more other apparatuses intended as recipients of the message.

21. The apparatus of claim 15, wherein the method is executed by a lower level data routing layer, the lower level data routing layer forming a middleware layer in the apparatus.
